(19) United States
(12) Patent Application Publication
(10) Pub. No.: US 2025/0060070 A1
(43) Pub. Date: Feb. 20, 2025

(54) SHIPBOARD BRACKET SYSTEM

(71) Applicant: ITI Engineering, LLC, Winter Springs, FL (US)

(72) Inventors: Gregory L. Atwood, Winter Springs, FL (US); David M. Lemelin, Winter Springs, FL (US)

(73) Assignee: ITI Engineering, LLC, Winter Springs, FL (US)

(21) Appl. No.: 18/808,767

(22) Filed: Aug. 19, 2024

Related U.S. Application Data
(60) Provisional application No. 63/520,431, filed on Aug. 18, 2023.

(51) Int. Cl. F16M 13/02

(52) U.S. Cl. CPC F16M 13/02

(57) ABSTRACT

The system may include a platform, a first horizontal member, a second horizontal member, a first vertical member, a second vertical member, a first front bracket, a second front bracket, a first rear bracket, a second rear bracket, a first clamping bracket, and a second clamping bracket. The first front bracket may secure to the first vertical member. The second front bracket may secure to the second vertical member. The first rear bracket may secure to the first clamping bracket about the first horizontal member. The second rear bracket may secure to the second clamping bracket about the second horizontal member. The first front bracket, second front bracket, first rear bracket, and second rear bracket may be configured to contact an electronic component and secure it in a fixed position relative to the platform.

### RELATED APPLICATIONS

This application claims priority under 35 U.S.C. § 119 (e) of U.S. Provisional Patent Application Ser. No. 63/520,431 (Attorney Docket No. 7687.00002) filed on Aug. 18, 2023 and titled SHIPBOARD BRACKET SYSTEM. The content of this application is incorporated herein by reference.

### FIELD OF THE INVENTION

The present invention relates to systems and methods for securing an electronic device to a shipboard rack. More specifically, the present invention relates to a bracket system designed to secure an electronic device to a shipboard rack while withstanding high levels of shock and vibration.

### BACKGROUND OF THE INVENTION

Electronic devices are commonly installed on ships. During operation of these ships, they are subjected to high environmental levels of shock and vibration. These forces are transmitted to the electronic devices and may damage or impede optimal performance of the devices. Traditional systems to mount electronic devices in shipboard environments physically secure the devices, often to rack systems, but do not provide adequate abatement of the environmental shock and vibration forces transmitted to the devices. Therefore, a need exists for a system to secure shipboard electronic devices while also mitigating the transmission of environmental shock and vibration forces to the device.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a system for reducing vibrations to a shipboard electronic component. The system may include a platform, a first horizontal member, a second horizontal member, a first vertical member, a second vertical member, a first front bracket, a second front bracket, a first rear bracket, a second rear bracket, a first clamping bracket, and a second clamping bracket.

The platform may have a front edge extending from a first side to a second side.

The first horizontal member may extend along a length of the first side of the platform, have an inner surface facing the platform, and have an opposing outer surface.

The second horizontal member may oppose the first horizontal member and extend along a length of the second side of the platform. The second horizontal member may have an inner surface facing the platform and an opposing outer surface.

The first vertical member may be adjacent a first end of the first horizontal member. The first vertical member may have a front surface proximate the front edge of the platform and an inner surface adjacent and at a ninety-degree angle to the front surface.

The second vertical member may be adjacent a first end of the second horizontal member. The second vertical member may have a front surface proximate the front edge of the platform and an inner surface adjacent and at a ninety-degree angle to the front surface.

The first front bracket may be secured to the first vertical member and may have a first inner surface contacting the front edge of the platform.

The second front bracket may be secured to the second vertical member and may have a first inner surface contacting the front edge of the platform.

The first rear bracket may have an inner surface adjacent the inner surface of the first horizontal member.

The second rear bracket may have an inner surface adjacent the inner surface of the second horizontal member.

The first clamping bracket may have an inner surface adjacent the outer surface of the first horizontal member. The first clamping bracket may be secured to the first rear bracket.

The second clamping bracket may have an inner surface adjacent the outer surface of the second horizontal member. The second clamping bracket may be secured to the second rear bracket.

The first front bracket, second front bracket, first rear bracket, and second rear bracket may be configured to contact the electronic component and secure it in a fixed position relative to the platform.

The first front bracket may be a mirror image of the second front bracket.

The first rear bracket may be a mirror image of the second rear bracket.

The system may also include a plurality of fasteners. The first front bracket may include a plurality of apertures extending through an entirety of a thickness of the first front bracket. Each of the plurality of fasteners may be carried by one of the plurality of apertures in the first front bracket and secured to the first vertical member. The second front bracket may include a plurality of apertures extending through an entirety of a thickness of the second front bracket. Each of the plurality of fasteners may be carried by one of the plurality of apertures in the second front bracket and secured to the second vertical member.

The first rear bracket may include a plurality of apertures extending through an entirety of a thickness of the first rear bracket. Each of a plurality of fasteners may carried by one of the plurality of apertures of the first rear bracket and secured to the first clamping bracket.

A vertical portion of the first clamping bracket may include a plurality of apertures extending through an entirety of a thickness of the first clamping bracket. Each of the plurality of fasteners may be carried by one of the plurality of apertures of the first clamping bracket and secured to the first rear bracket.

The first front bracket may include a second inner surface adjacent and at a ninety-degree angle to the first inner surface. The second inner surface may be adapted to contact the shipboard electronic component.

The first front bracket may include a first planar surface, a second planar surface, and an angled corner surface. The first planar surface may be adapted to contact the front surface of the first vertical member. The second planar surface may be at a ninety-degree angle to the first planar surface and perpendicular to the first planar surface. The angled corner surface may extend between the first planar surface and the second planar surface. The second planar surface may be adapted to contact the inner surface of the first vertical member. The angled corner surface may form a 135-degree angle with the first planar surface. The angled corner surface may form a 135-degree angle with the second planar surface.

The first front bracket may include a horizontal portion, vertical portion, and an angled surface. The horizontal portion may extend parallel to the first inner surface. The vertical portion may extend perpendicular to the horizontal portion. The angled surface may extend an entirety of the distance from the horizontal portion to the vertical portion. The angled surface may form a 135-degree angle with each the horizontal portion and the vertical portion.

In one embodiment, the first front bracket may include a vertical portion, a side surface, a back surface, and an angled surface. The vertical portion may extend perpendicular to the first inner surface. The side surface may oppose the inner surface of the first vertical member. The back surface may oppose the front surface of the first vertical member. The angled surface may extend directly between the side surface and the back surface. The angled surface may form a 210-degree angle with the side surface and a 240-degree angle with the back surface.

The first front bracket may include a horizontal portion, a vertical portion, a second inner surface, a third inner surface, and an arcuate surface. The first inner surface may be located along the horizontal portion. The vertical portion may extend perpendicular to the horizontal portion. The second inner surface may form a ninety-degree angle with the first inner surface and be located along the horizontal portion. The third inner surface may be located at a 270-degree angle to the second inner surface and may form a ninety-degree angle with the first inner surface. An arcuate surface may extend directly between the second inner surface and the third inner surface.

The first front bracket may include a vertical portion having a side surface opposing the first vertical member. The third inner surface may oppose the side surface.

In such an embodiment, the horizontal portion may have a total thickness from a front surface to a chamfer end. A first thickness may extend from the front surface to a chamfer start located on a top surface of the horizontal portion. A second thickness may extend from the chamfer start to the chamfer end. The combination of the first thickness and second thickness equals the total thickness. A chamfer may be located along a top surface of the horizontal portion beginning at the chamfer start and ending at the chamfer end. The chamfer may form a 114-degree angle with the non-chamfered portion of the top surface of the horizontal portion.

The first rear bracket may include a second inner surface adapted to contact the shipboard electronic component.

The first rear bracket may include a horizontal portion, a vertical portion, and an angled surface. The horizontal portion may extend parallel to the second inner surface. The vertical portion may extend perpendicular to the horizontal portion. The angled surface may extend an entirety of the distance from the horizontal portion to the vertical portion. The angled surface may form a 135-degree angle with each the horizontal portion and the vertical portion.

The first rear bracket may include a vertical portion, a side surface, a back surface, and an angled surface. The vertical portion may extend perpendicular to the second inner surface and parallel to the first inner surface. The side surface may oppose the inner surface of the first horizontal member. The back surface may be positioned perpendicular to the side surface and the first horizontal member. The angled surface may extend directly between the side surface and the back surface. The angled surface may form a 210-degree angle with the side surface and a 240-degree angle with the back surface.

In one embodiment, the first rear bracket may include a horizontal portion, a vertical portion, a second inner surface, a third inner surface, and an arcuate surface. The vertical portion may extend perpendicular to the horizontal portion. The second inner surface may form a ninety-degree angle with the first inner surface and be located along the horizontal portion. The third inner surface may be located at a 270-degree angle to the second inner surface and parallel to the first inner surface. The arcuate surface may extend directly between the second inner surface and the third inner surface.

The first rear bracket may include a vertical portion having a side surface opposing the first horizontal member. In such an embodiment, the third inner surface may oppose the side surface.

The horizontal portion may have a total thickness from a front surface to a chamfer end. A first thickness may extend from the front surface to a chamfer start located on a top surface of the horizontal portion. A second thickness may extend from the chamfer start to the chamfer end. The combination of the first thickness and second thickness may equal the total thickness. A chamfer may be located along a top surface of the horizontal portion beginning at the chamfer start and ending at the chamfer end. The chamfer may form a 114-degree angle with the non-chamfered portion of the top surface of the horizontal portion.

The first clamping bracket may include a vertical portion and a horizontal portion. The vertical portion may extend parallel to the inner surface. The horizontal portion may be secured to a first end of the vertical portion and form a ninety-degree angle therewith.

### BRIEF DESCRIPTION OF THE DRAWINGS

Some embodiments of the present invention are illustrated as an example and are not limited by the figures of the accompanying drawings, in which like references may indicate similar elements.

FIG. 1 is an environmental perspective view of the system for reducing vibrations to a shipboard electronic component in combination with the electronic component according to an embodiment of the present invention.

FIG. 2 is an environmental view of the system of FIG. 1.

FIG. 3 is a front perspective view of a second front bracket of the system of FIG. 1.

FIG. 4 is top plan view of the second front bracket of FIG. 3.

FIG. 5 is a front elevation view of the second front bracket of FIG. 3.

FIG. 6 is a rear elevation view of the second front bracket of FIG. 3.

FIG. 7 is a cross-section of the second front bracket of FIG. 3 taken through the line A-A of FIG. 6.

FIG. 8 is a right-side elevation view of the second front bracket of FIG. 3.

FIG. 9 is a left-side elevation view of the second front bracket of FIG. 3.

FIG. 10 is a front perspective view of a first front bracket of the system of FIG. 1.

FIG. 11 is a top plan view of the first front bracket of FIG. 10.

FIG. 12 is a front elevation view of the first front bracket of FIG. 10.

FIG. 13 is a rear elevation view of the first front bracket of FIG. 10.

FIG. 14 is a cross-section of the first front bracket of FIG. 10 taken through the line A-A of FIG. 13.

FIG. 15 is a left side elevation view of the first front bracket of FIG. 10.

FIG. 16 is a right side elevation view of the first front bracket of FIG. 10.

FIG. 17 is a rear perspective view of the first rear bracket of the system of FIG. 1.

FIG. 18 is a top plan view of the first rear bracket of FIG. 17.

FIG. 19 is a rear elevation view of the first rear bracket of FIG. 17.

FIG. 20 is a cross-section of the first rear bracket of FIG. 17 taken through the line A-A of FIG. 19.

FIG. 21 is a front elevation view of the first rear bracket of FIG. 17.

FIG. 22 is a cross-section of the first rear bracket of FIG. 17 taken through the line A-A of FIG. 21.

FIG. 23 is a right-side elevation view of the first rear bracket of FIG. 17.

FIG. 24 is a left-side elevation view of the first rear bracket of FIG. 17.

FIG. 25 is a rear perspective view of the second rear bracket of the system of FIG. 1.

FIG. 26 is a top plan view of the second rear bracket of FIG. 25.

FIG. 27 is a rear elevation view of the second rear bracket of FIG. 25.

FIG. 28 is a cross-section of the second rear bracket of FIG. 25 taken through the line A-A of FIG. 27.

FIG. 29 is a front elevation view of the second rear bracket of FIG. 25.

FIG. 30 is a cross-section of the second rear bracket of FIG. 25 taken through the line A-A of FIG. 29.

FIG. 31 is a right-side elevation view of the second rear bracket of FIG. 25.

FIG. 32 is a left-side elevation view of the second rear bracket of FIG. 25.

FIG. 33 is a left-side elevation view of the second rear bracket of FIG. 25.

FIG. 34 is a front elevation view of the clamping bracket of the system of FIG. 1.

FIG. 35 is a right-side elevation view of the clamping bracket of FIG. 35.

FIG. 36 is a rear elevation view of the clamping bracket of FIG. 35.

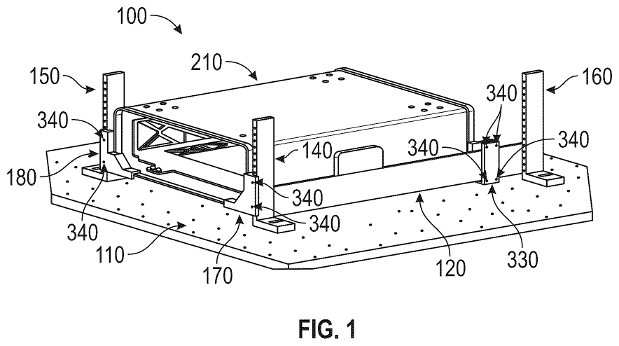

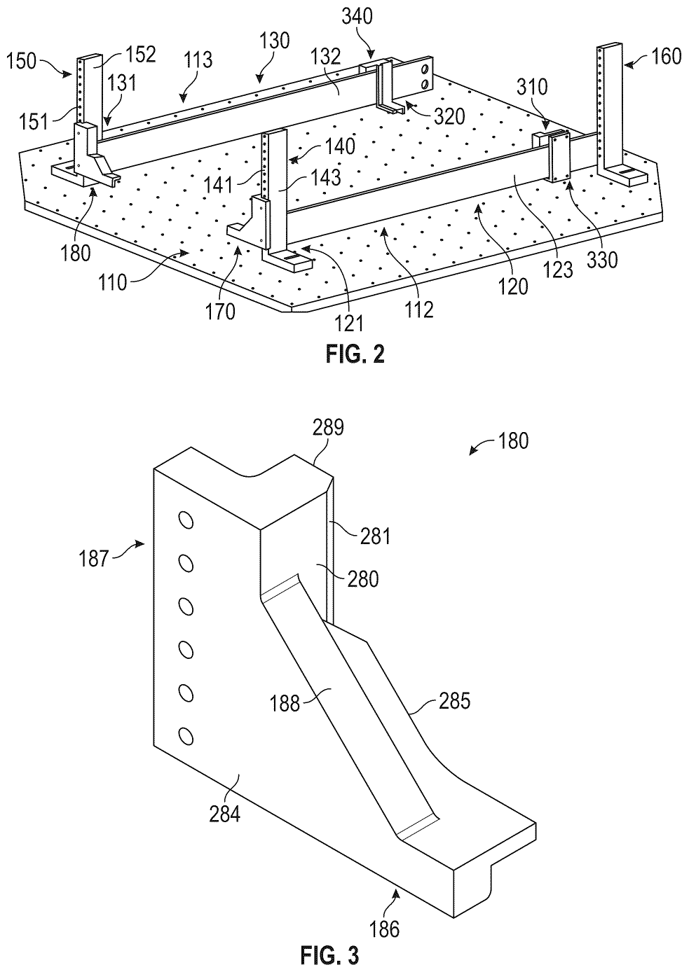

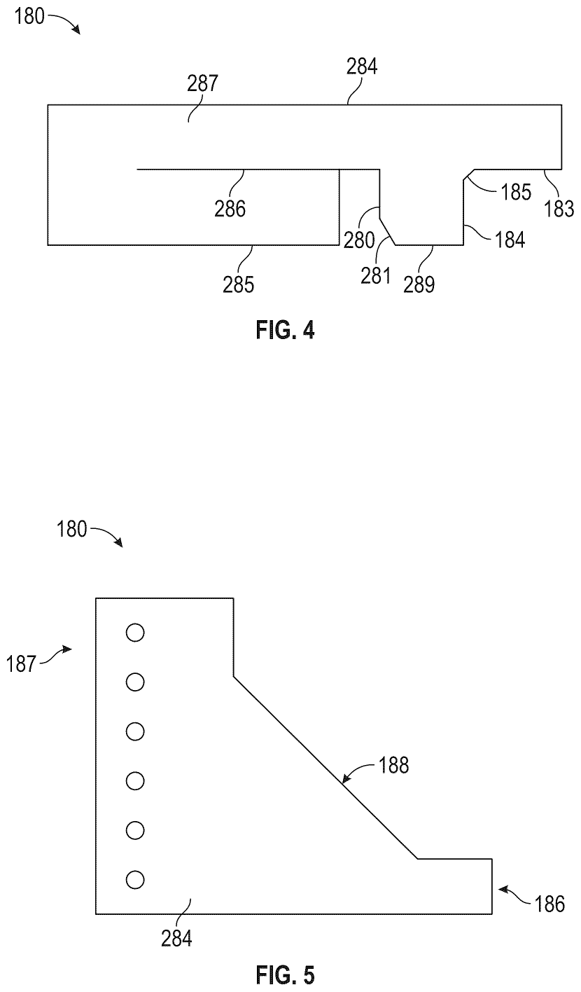

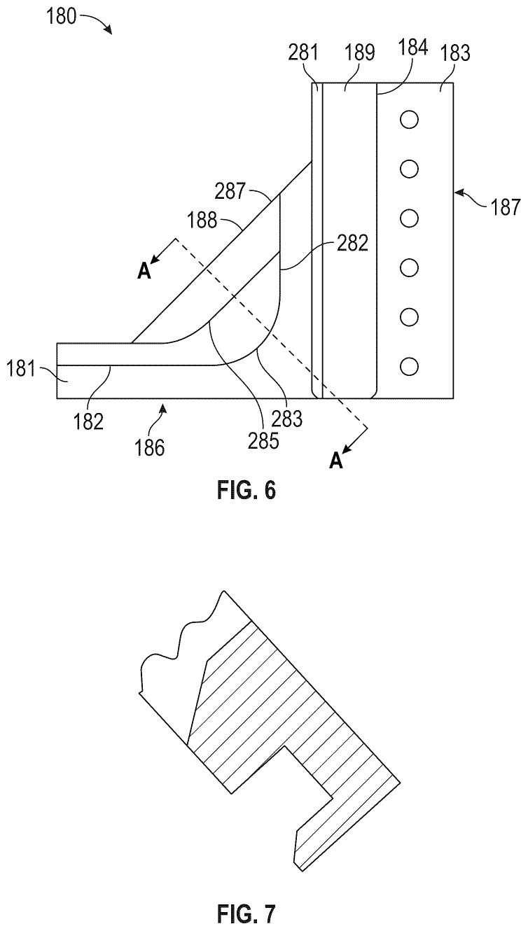

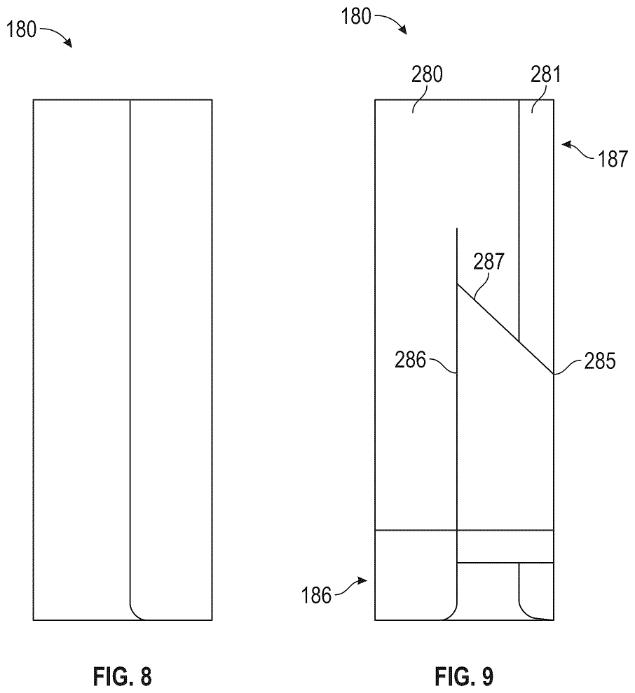

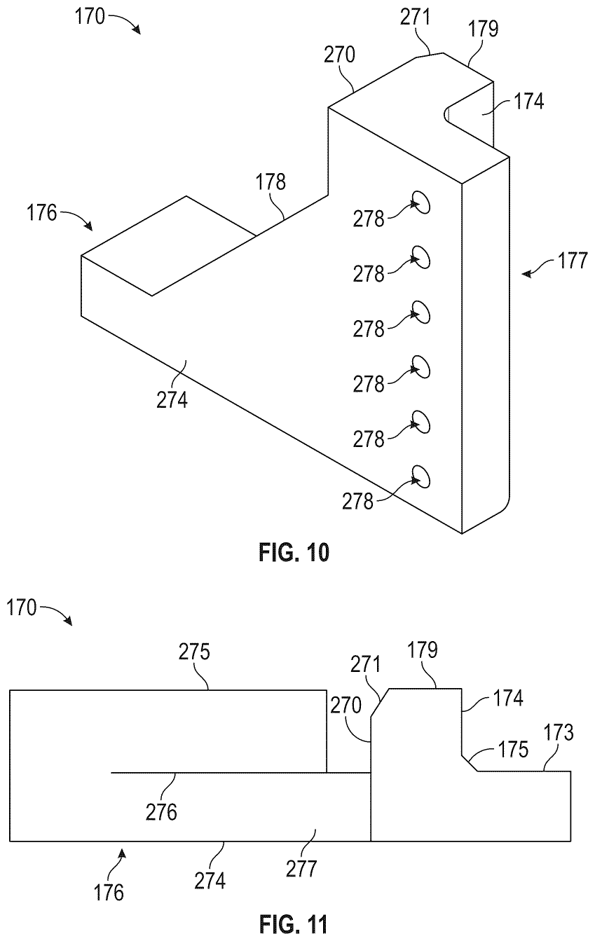

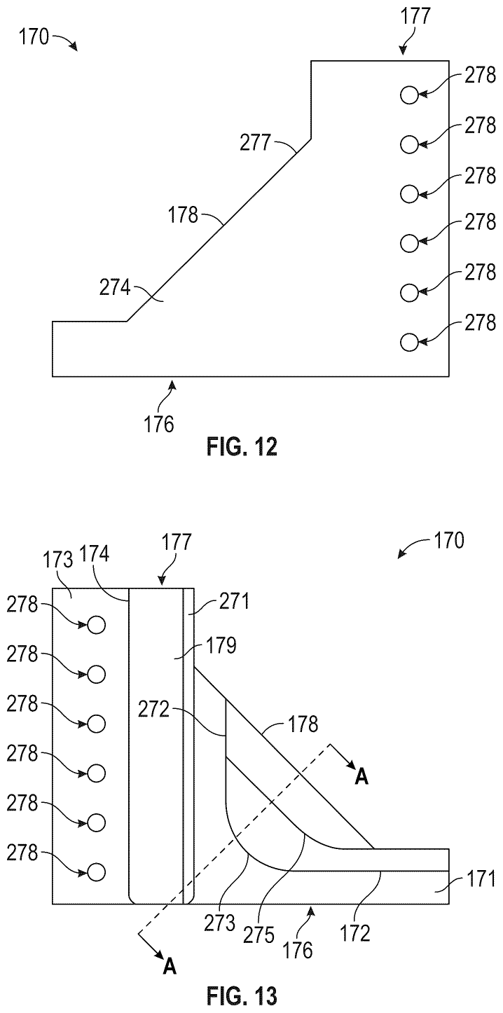

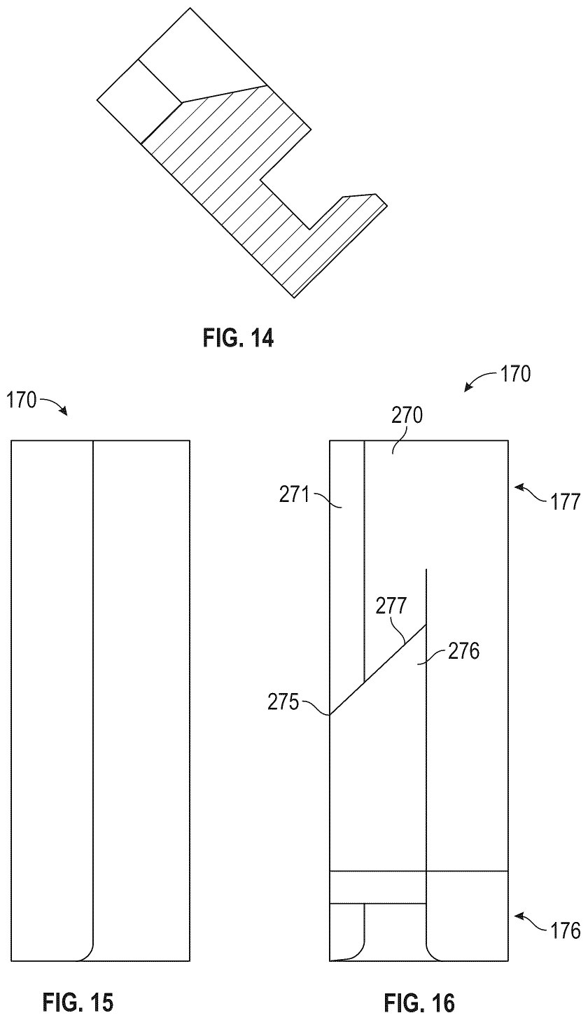

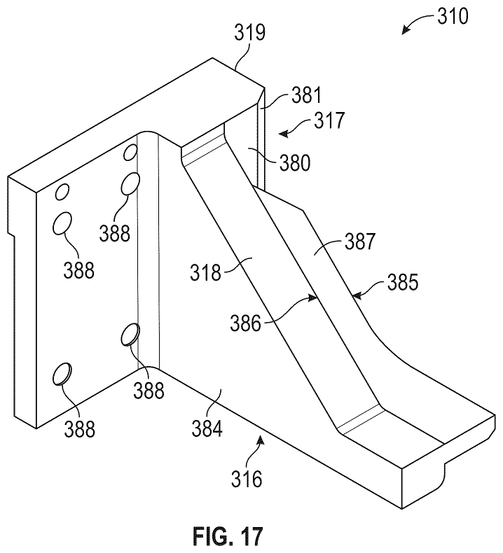

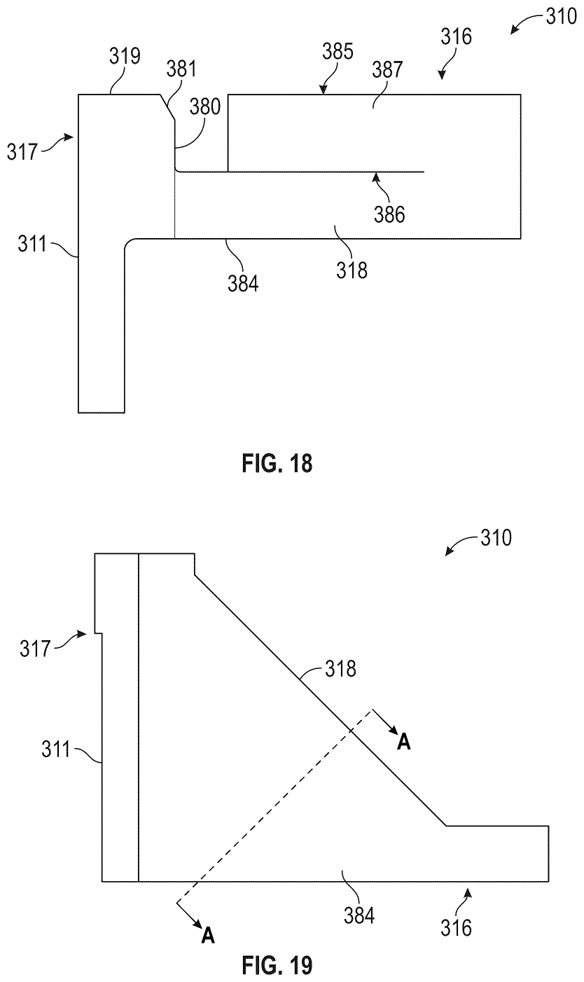

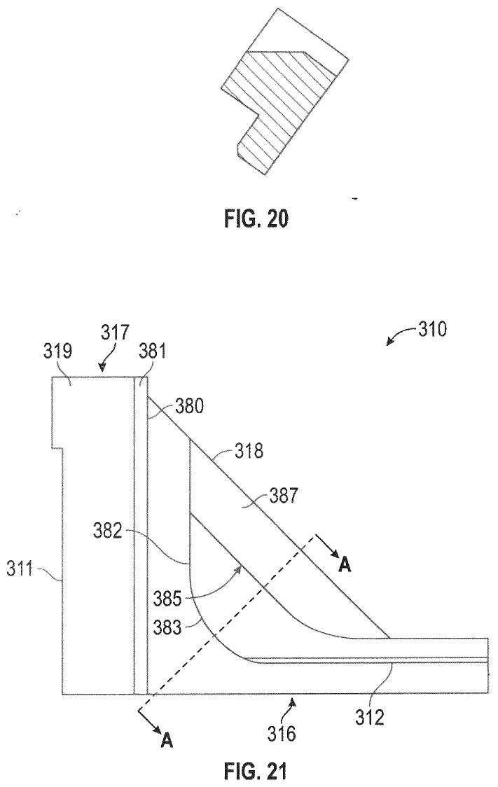

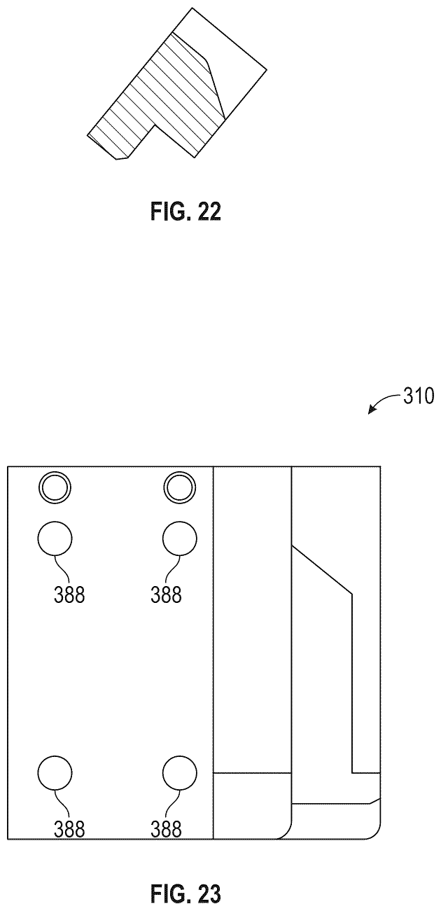

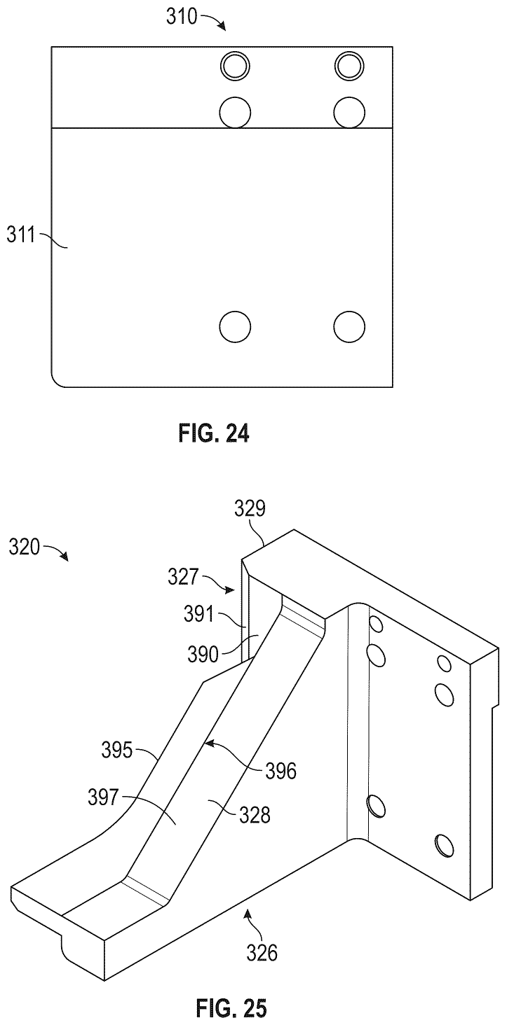

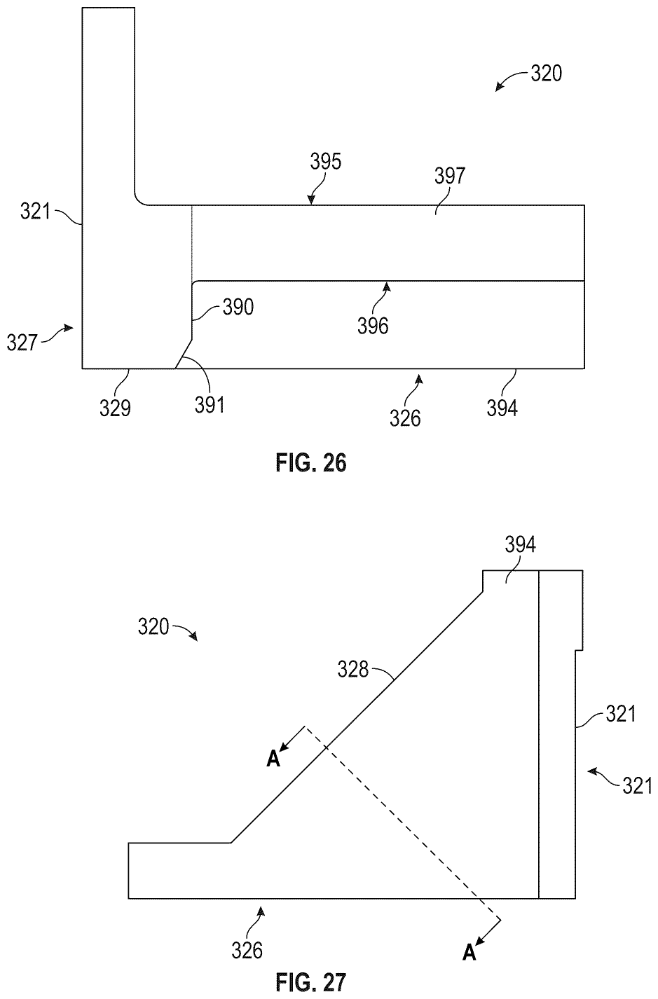

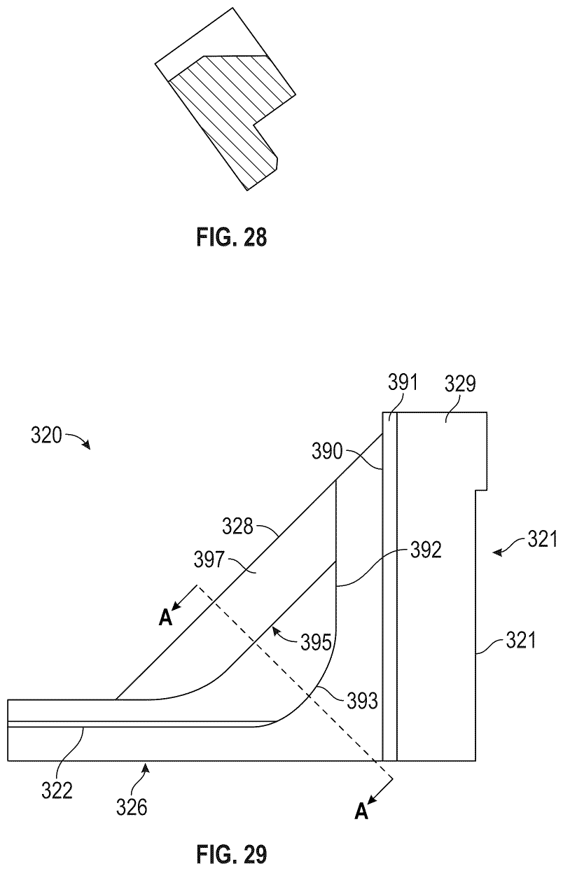

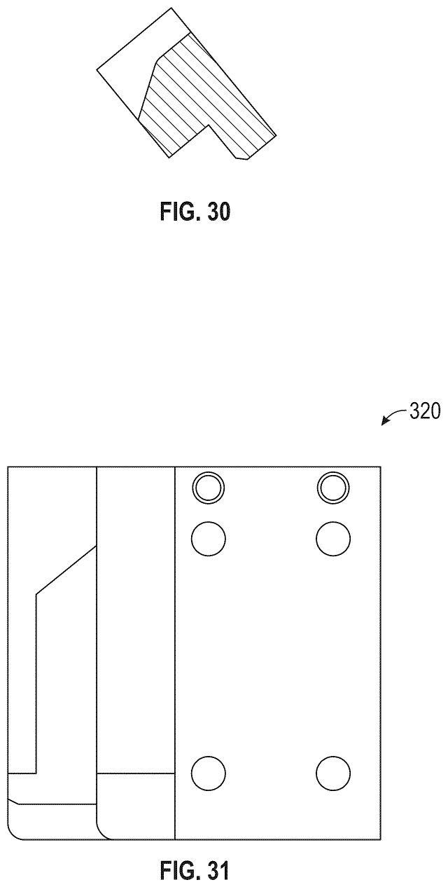

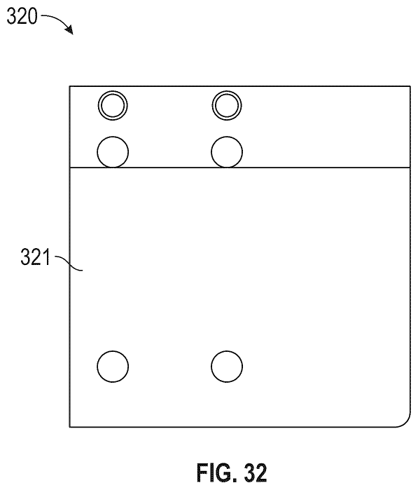

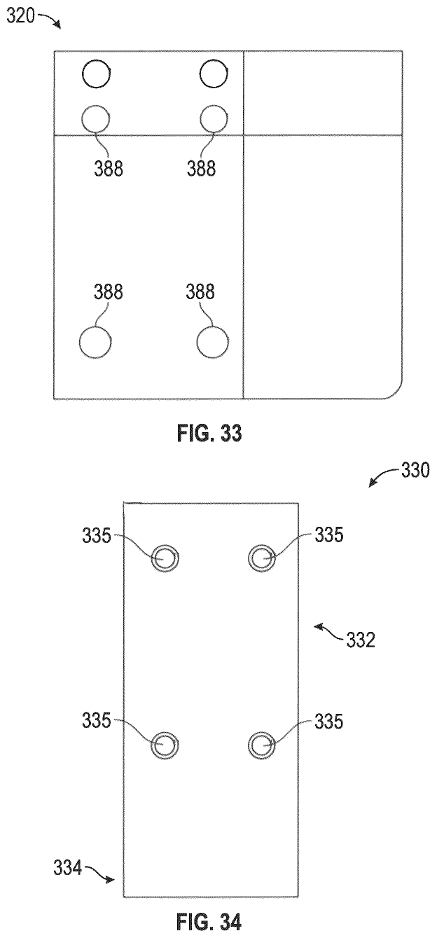

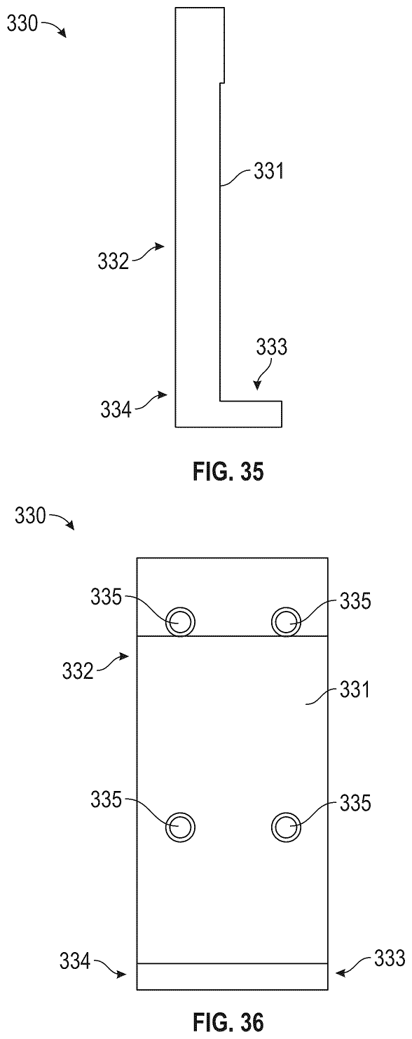

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a system for reducing vibrations to a shipboard electronic component 100. The system 100 may secure a case of an electronic component 210 to a shipboard rack. In one embodiment, the electronic component 210 may weigh up to 100 lbs. The system 100 may be designed to withstand a 65 g vertical and 26 g lateral force. The system 100 may be specifically designed to reduce the effects of shock and vibration imparted to the electronic component 210 secured by the system 100. The system 100 may be designed to secure an electronic component 210 to a shipboard rack, which may be a design commonly employed by the United States Navy. In one embodiment, components of the rack may be part of the system 100. The system 100 may be designed to withstand shock caused by explosions.

The system 100 may include six individual brackets and at least a portion of a shipboard rack. The shipboard rack may include two horizontal members 120, 130 and four vertical members 140, 150, 160. A first horizontal member 120 may be secured to and extend between a first vertical member 140 and a third vertical member 160. A second horizontal member 130 may be secured to and extend between a second vertical member 150 and a fourth vertical member. A platform 110 may be positioned in an area enclosed be a perimeter formed by a projection of lines joining the first vertical member 140 to the second vertical member 150, extending along the second horizontal member 130 from the second vertical member 150 to the fourth vertical member, joining the fourth vertical member to the third vertical member 160, and extending along the first horizontal member 120 from the third vertical member 150 to the first vertical member 140.

The platform 110 may be carried by the first horizontal member 120 and the second horizontal member 130. The platform 110 may form a planar surface upon which the electronic component 210 may be carried. The platform 110 may have a first side 112 adjacent to the first horizontal member 120. The platform 110 may have a second side 113 opposing the first side 112 and adjacent to the second horizontal member 130. A front edge 111 of the platform 110 may extend from the first side 112 to the second side 113.

The first horizontal member 120 may extend along at least a portion of the length of the first side 112 of the platform 110. The first horizontal member 120 may have an inner surface facing the platform 110 and an opposing outer surface 123. A first end 121 of the first horizontal member 120 may abut the first vertical member 140 and form a right-angle therewith.

The second horizontal member 130 may extend along at least a portion of the length of the second side 113 of the platform 110. The second horizontal member 130 may have an inner surface 132 facing the platform 110 and an opposing outer surface. A first end 131 of the second horizontal member 130 may abut the second vertical member 150 and form a right-angle therewith.

The first vertical member 140 may be adjacent the first end 121 of the first horizontal member 120. The first vertical member 140 may form a rectangular prism. The first vertical member 140 may have a front surface 141 proximate and parallel to the front edge 111 of the platform 110. The first vertical member 140 may have an inner surface adjacent to and at a ninety-degree angle to the front surface 141. The inner surface may oppose an outer surface 143.

The second vertical member 150 may be adjacent the first end 131 of the second horizontal member 130. The second vertical member 150 may form a rectangular prism. The second vertical member 150 may have a front surface 151 proximate and parallel to the front edge 111 of the platform 110. The second vertical member 150 may have an inner surface 152 adjacent to and at a ninety-degree angle to the front surface 151.

The system may include two front brackets 170, 180. The first front bracket 170 and the second front bracket 180 may be mirror images of one another when flipped along a vertical axis. The first front bracket 170 may be secured to the first vertical member 140. A first inner surface 171 of the first front bracket 170 may contact the electronic component 210. The first front bracket 170 may have a plurality of apertures through an entirety of a thickness and aligned with a plurality of apertures located in the first vertical member 140. A fastener may be carried by each of the plurality of apertures to secure the first front bracket 170 to the first vertical member 140. One or more of the plurality of apertures in the first vertical member 140 may be threaded. A threaded fastener may be passed through an aperture in the first front bracket 170 and engage the threads of the first vertical member 140 to secure the first front bracket 170 thereto.

The first front bracket 170 may further include a second inner surface 172. The second inner surface 172 may be adjacent to and form a ninety-degree angle with the first inner surface 171. The second inner surface 172 may rest upon a lip of the electronic competent 210.

The first front bracket 170 may include a first planar surface 173. This first planar surface 173 may contact the front surface 141 of the first vertical member 140. The first front bracket 170 may include a second planar surface 174. The second planar surface 174 may be formed at a ninety-degree angle to the first planar surface 173 and perpendicular to the first planar surface 173. An angled corner surface 175 may extend from the first planar surface 173 to the second planar surface 174. The second planar surface 174 may be adapted to contact the inner surface of the first vertical member 140. The angled corner surface 175 may be a chamfer forming a 135-degree angle with the first planar surface 173. The angled corner surface may also form a 135-degree angle with the second planar surface 174.

The first front bracket 170 may still further include a horizontal portion 176 extending parallel to the first inner surface 171. A vertical portion 177 may extend perpendicular to the horizontal portion 176. An angled portion 178, which may be a chamfer, may extend along an entirety of the distance from the horizontal portion 176 to the vertical portion 177. The angled surface 178 may form a 135-degree angle with both the horizontal portion 176 and the vertical portion 177.

The first front bracket 170 may include a side surface 270 opposing the inner surface of the first vertical member 140 and a back surface 179 opposing the front surface 141 of the first vertical member 140. An angled surface 271 may extend directly between the side surface 270 and the back surface 179. The angled surface 271 may be a chamfer and form a 210-degree angle with the side surface 270 and a 240-degree angle with the back surface 179.

The first front bracket 170 may still further include a horizontal portion 176 wherein the first inner surface 171 is located along the horizontal portion 176. The vertical portion 177 may extend perpendicular to the horizontal portion 176. A second inner surface 172, which forms a ninety-degree angle with the first inner surface may be located along the horizontal portion 176. A third inner surface 272 may be located at a 270-degree angle to the second inner surface 172 and form a ninety-degree angle with the first inner surface 171. An arcuate surface 273 may extend directly between the second inner surface 172 and the third inner surface 272. The vertical portion 177 may have a side surface 271 opposing the first vertical member 140. The third inner surface 272 may oppose the side surface 270.

The horizontal portion 176 may have a total thickness extending from a front surface 274 to a chamfer end 275. A first thickness may extend from the front surface 274 to a chamfer start 276 located on a top surface 277 of the horizontal portion 176. A second thickness extends from the chamfer start 276 to the chamfer end 275. The combination of the first thickness and second thickness equals the total thickness. A chamfer may be located along the top surface 277 of the horizontal portion 176 beginning at the chamfer start 276 and ending at the chamfer end 275. The chamfer may form a 114-degree angle with the non-chamfered portion of the top surface 277 of the horizontal portion 176.

The second front bracket 180 may be secured to the second vertical member 150. A first inner surface 181 of the second front bracket 180 may contact the front edge 111 of the platform 110. The second front bracket 180 may have a plurality of apertures through an entirety of a thickness and aligned with a plurality of apertures located in the second vertical member 150. A fastener may be carried by each of the plurality of apertures to secure the second front bracket 180 to the second vertical member 150. One or more of the plurality of apertures in the second vertical member 150 may be threaded. A threaded fastener may be passed through an aperture in the first front bracket 180 and engage the threads of the second vertical member 150 to secure the second front bracket 180 thereto.

The second front bracket 180 may further include a second inner surface 182. The second inner surface 182 may be adjacent to and form a ninety-degree angle with the first inner surface 181. The second inner surface 182 may rest upon a lip of the electronic competent 210.

The second front bracket 180 may include a first planar surface 183. This first planar surface 183 may contact the front surface 151 of the second vertical member 150. The second front bracket 180 may include a second planar surface 184. The second planar surface 184 may be formed at a ninety-degree angle to the first planar surface 183 and perpendicular to the first planar surface 183. An angled corner surface 185 may extend from the first planar surface 183 to the second planar surface 184. The second planar surface 184 may be adapted to contact the inner surface 152 of the second vertical member 150. The angled corner surface 185 may be a chamfer forming a 135-degree angle with the first planar surface 183. The angled corner surface may also form a 135-degree angle with the second planar surface 184.

The second front bracket 180 may still further include a horizontal portion 186 extending parallel to the first inner surface 181. A vertical portion 187 may extend perpendicular to the horizontal portion 186. An angled portion 188, which may be a chamfer, may extend along an entirety of the distance from the horizontal portion 186 to the vertical portion 187. The angled surface 188 may form a 135-degree angle with both the horizontal portion 186 and the vertical portion 187.

The second front bracket 180 may include a side surface 280 opposing the inner surface 152 of the second vertical member 150 and a back surface 189 opposing the front surface 151 of the first vertical member 150. An angled surface 281 may extend directly between the side surface 280 and the back surface 189. The angled surface 281 may be a chamfer and form a 210-degree angle with the side surface 280 and a 240-degree angle with the back surface 189.

The second front bracket 180 may still further include a horizontal portion 186 wherein the first inner surface 181 is located along the horizontal portion 186. The vertical portion 187 may extend perpendicular to the horizontal portion 186. A second inner surface 182, which forms a ninety-degree angle with the first inner surface 181 may be located along the horizontal portion 186. A third inner surface 282 may be located at a 270-degree angle to the second inner surface 182 and form a ninety-degree angle with the first inner surface 181. An arcuate surface 283 may extend directly between the second inner surface 182 and the third inner surface 282. The vertical portion 187 may have a side surface 281 opposing the second vertical member 150. The third inner surface 282 may oppose the side surface 280.

The horizontal portion 186 may have a total thickness extending from a front surface 284 to a chamfer end 285. A first thickness may extend from the front surface 284 to a chamfer start 286 located on a top surface 287 of the horizontal portion 186. A second thickness extends from the chamfer start 286 to the chamfer end 285. The combination of the first thickness and second thickness equals the total thickness. A chamfer may be located along the top surface 287 of the horizontal portion 186 beginning at the chamfer start 286 and ending at the chamfer end 285. The chamfer may form a 114-degree angle with the non-chamfered portion of the top surface 287 of the horizontal portion 186.

The system may include two rear brackets 310, 320. The first rear bracket 310 and the second rear bracket 320 may be mirror images of one another when flipped along a vertical axis. The first rear bracket 310 may be secured to the first horizontal member 120. A inner surface 311 of the first rear bracket 310 may contact the inner surface of the first horizontal member 120. The first rear bracket 310 may have a plurality of apertures 388 through an entirety of a thickness and aligned with a plurality of apertures located in a first clamping bracket 330. A fastener may be carried by each of the plurality of apertures 388 located in the first rear bracket 310 and each of the plurality of apertures 335 in the first clamping bracket 330 to secure the first rear bracket 310 to the first clamping bracket 330.

The first rear bracket 310 may further include a second inner surface 312 adapted to contact a lip of the electronic component 210 to maintain it in a fixed position.

The first rear bracket 310 may include a horizontal portion 316 extending parallel to the second inner surface 312. The first rear bracket 310 may also include a vertical portion 317 extending perpendicular to the horizontal portion 316. An angled surface 318 may extend an entirety of the distance from the horizontal portion 316 to the vertical portion 317. The angled surface 318 may form a 135-degree angle with each the horizontal portion 316 and the vertical portion 317.

The first rear bracket 310 may further include a vertical portion 317 extending perpendicular to the second inner surface 312 and parallel to the first inner surface 311. A side surface 380 may oppose the inner surface of the first horizontal member 120. A back surface 319 may be positioned perpendicular to the side surface 380 and the first horizontal member 120. An angled surface 381, which may be a chamfer, may extend directly between the side surface 380 and the back surface 319. The angled surface 381 may form a 210-degree angle with the side surface 380 and a 240-degree angle with the back surface 319.

The first rear bracket 310 may include a horizontal portion 316 and a vertical portion 317 extending perpendicular to the horizontal portion 316. A second inner surface 312 may form a ninety-degree angle with the first inner surface 311 and be located along the horizontal portion 316. A third inner surface 382 may be located at a 270-degree angle to the second inner surface 312 and parallel to the first inner surface 311. An arcuate surface 383 may extend directly between the second inner surface 312 and the third inner surface 382. The vertical portion 317 may have a side surface 380 opposing the first horizontal member 120. The third inner surface 382 may oppose the side surface 380.

The horizontal portion 316 may have a total thickness from a front surface 384 to a chamfer end 385. A first thickness may extend from the front surface 384 to a chamfer start 386 located on a top surface 387 of the horizontal portion 316. A second thickness may extend from the chamfer start 386 to the chamfer end 385. The combination of the first thickness and second thickness equals the total thickness. A chamfer may be located along a top surface 387 of the horizontal portion 316 beginning at the chamfer start 386 and ending at the chamfer end 385. The chamfer may form a 114-degree angle with the non-chamfered portion of the top surface 387 of the horizontal portion 316.

The second rear bracket 320 may be secured to the second horizontal member 130. A inner surface 321 of the second rear bracket 320 may contact the inner surface 132 of the second horizontal member 130. The second rear bracket 320 may have a plurality of apertures through an entirety of a thickness and aligned with a plurality of apertures located in a second clamping bracket 330. A fastener may be carried by each of the plurality of apertures to secure the second rear bracket 320 to the second clamping bracket 330.

The second rear bracket 320 may further include a second inner surface 322 adapted to contact a lip of the electronic component 210 to maintain it in a fixed position.

The second rear bracket 320 may include a horizontal portion 326 extending parallel to the second inner surface 322. The second rear bracket 320 may also include a vertical portion 327 extending perpendicular to the horizontal portion 326. An angled surface 328 may extend an entirety of the distance from the horizontal portion 326 to the vertical portion 327. The angled surface 328 may form a 135-degree angle with each the horizontal portion 326 and the vertical portion 327.

The second rear bracket 320 may further include a vertical portion 327 extending perpendicular to the second inner surface 322 and parallel to the first inner surface 321. A side surface 390 may oppose the inner surface 132 of the second horizontal member 130. A back surface 329 may be positioned perpendicular to the side surface 390 and the second horizontal member 130. An angled surface 391, which may be a chamfer, may extend directly between the side surface 390 and the back surface 329. The angled surface 391 may form a 210-degree angle with the side surface 390 and a 240-degree angle with the back surface 329.

The second rear bracket 320 may include a horizontal portion 326 and a vertical portion 327 extending perpendicular to the horizontal portion 326. A second inner surface 322 may form a ninety-degree angle with the first inner surface 321 and be located along the horizontal portion 326. A third inner surface 392 may be located at a 270-degree angle to the second inner surface 322 and parallel to the first inner surface 321. An arcuate surface 393 may extend directly between the second inner surface 322 and the third inner surface 392. The vertical portion 327 may have a side surface 390 opposing the second horizontal member 130. The third inner surface 392 may oppose the side surface 390.

The horizontal portion 326 may have a total thickness from a front surface 394 to a chamfer end 395. A first thickness may extend from the front surface 394 to a chamfer start 396 located on a top surface 397 of the horizontal portion 326. A second thickness may extend from the chamfer start 396 to the chamfer end 395. The combination of the first thickness and second thickness equals the total thickness. A chamfer may be located along a top surface 397 of the horizontal portion 326 beginning at the chamfer start 396 and ending at the chamfer end 395. The chamfer may form a 114-degree angle with the non-chamfered portion of the top surface 397 of the horizontal portion 326.

The first clamping bracket 330 may have an inner surface 331 adjacent the outer surface 123 of the first horizontal member 120. A plurality of fasteners 340 may secure the first clamping bracket 330 to the first horizontal member 120 with at least two fasteners 340 located above the first horizontal member 120 and at least two additional fasteners 340 located below the first horizontal member 120.

The first clamping bracket 330 may include a vertical portion 332 extending parallel to the inner surface 331 and a horizontal portion 333 secured to a first end 334 of the vertical portion 332 and forming a ninety-degree angle therewith.

The system 100 may include two identical clamping brackets 330. The second clamping bracket 330 may have an inner surface 331 adjacent the outer surface 133 of the second horizontal member 130. A plurality of fasteners 340 may secure the second clamping bracket 330 to the second horizontal member 130 with at least two fasteners 340 located above the second horizontal member 130 and at least two additional fasteners 340 located below the second horizontal member 130.

The second clamping bracket 330 may include a vertical portion 332 extending parallel to the inner surface 331 and a horizontal portion 333 secured to a first end 334 of the vertical portion 332 and forming a ninety-degree angle therewith.

The first front bracket 170, second front bracket 180, first rear bracket 310, and second rear bracket 320 may be configured to contact a lip of the electronic component 210 and secure it in a fixed position relative to the platform 110.

In one embodiment, each bracket 170, 180, 310, 320, 330 of the system 100 may be constructed from machined aluminum 6061. During FEA analysis, the system 100 may result in a maximum Von Mises stress of 20 ksi, a maximum displacement of 0.3885 inches and a maximum strain of 0.002 in/in incurred by the electronic component 210 secured by the system 100.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

What is claimed is:

1. A system for reducing vibrations to a shipboard electronic component comprising:
a platform having a front edge extending from a first side to a second side;
a first horizontal member extending along a length of the first side of the platform, having an inner surface facing the platform and an opposing outer surface;
a second horizontal member opposing the first horizontal member and extending along a length of the second side of the platform, having an inner surface facing the platform and an opposing outer surface;
a first vertical member adjacent a first end of the first horizontal member and having a front surface proximate the front edge of the platform and an inner surface adjacent and at a ninety-degree angle to the front surface;
a second vertical member adjacent a first end of the second horizontal member and having a front surface proximate the front edge of the platform and an inner surface adjacent and at a ninety-degree angle to the front surface;
a first front bracket secured to the first vertical member and having a first inner surface contacting the electronic component;
a second front bracket secured to the second vertical member and having a first inner surface contacting the electronic component;
a first rear bracket having an inner surface adjacent the inner surface of the first horizontal member;
a second rear bracket having an inner surface adjacent the inner surface of the second horizontal member;
a first clamping bracket having an inner surface adjacent the outer surface of the first horizontal member and secured to the first rear bracket;
a second clamping bracket having an inner surface adjacent the outer surface of the second horizontal member and secured to the second rear bracket;
wherein the first front bracket, second front bracket, first rear bracket, and second rear bracket are configured to contact the electronic component and secure it in a fixed position relative to the platform.

2. The system of claim 1 wherein the first front bracket is a mirror image of the second front bracket.

3. The system of claim 1 wherein the first rear bracket is a mirror image of the second rear bracket.

4. The system of claim 1 further comprising a plurality of fasteners; and
wherein the first front bracket comprises a plurality of apertures extending through an entirety of a thickness of the first front bracket; and
wherein each of the plurality of fasteners is carried by one of the plurality of apertures and secured to the first vertical member.

5. The system of claim 1 wherein the first front bracket further comprises a second inner surface adjacent and at a ninety-degree angle to the first inner surface;
wherein the second inner surface is adapted to contact the shipboard electronic component.

6. The system of claim 1 wherein the first front bracket comprises:
a first planar surface adapted to contact the front surface of the first vertical member;
a second planar surface at a ninety-degree angle to the first planar surface and perpendicular to the first planar surface; and
an angled corner surface extending between the first planar surface and the second planar surface; and
wherein the second planar surface is adapted to contact the inner surface of the first vertical member;
wherein the angled corner surface forms a 135-degree angle with the first planar surface; and
wherein the angled corner surface forms a 135-degree angle with the second planar surface.

7. The system of claim 1 wherein the first front bracket further comprises:
a horizontal portion extending parallel to the first inner surface;
a vertical portion extending perpendicular to the horizontal portion; and
an angled surface extending an entirety of the distance from the horizontal portion to the vertical portion; and
wherein the angled surface forms a 135-degree angle with the horizontal portion; and
wherein the angled surface forms a 135-degree angle with the vertical portion.

8. The system of claim 1 wherein the first front bracket further comprises:
a vertical portion extending perpendicular to the first inner surface;
a side surface opposing the inner surface of the first vertical member;
a back surface opposing the front surface of the first vertical member; and
an angled surface extending directly between the side surface and the back surface; and
wherein the angled surface forms a 210-degree angle with the side surface; and
wherein the angled surface forms a 240-degree angle with the back surface.

9. The system of claim 1 wherein the first front bracket further comprises:
a horizontal portion wherein the first inner surface is located along the horizontal portion;
a vertical portion extending perpendicular to the horizontal portion;
a second inner surface forming a ninety-degree angle with the first inner surface and located along the horizontal portion;
a third inner surface located at a 270-degree angle to the second inner surface and forming a ninety-degree angle with the first inner surface;
an arcuate surface extending directly between the second inner surface and the third inner surface.

10. The system of claim 9 wherein the first front bracket further comprises:
a vertical portion having a side surface opposing the first vertical member; and
wherein the third inner surface opposes the side surface.

11. The system of claim 10 wherein the horizontal portion has a total thickness from a front surface to a chamfer end;
wherein a first thickness extends from the front surface to a chamfer start located on a top surface of the horizontal portion;
wherein a second thickness extends from the chamfer start to the chamfer end;
wherein the combination of the first thickness and second thickness equals the total thickness;
wherein a chamfer is located along a top surface of the horizontal portion beginning at the chamfer start and ending at the chamfer end;
wherein the chamfer forms a 114-degree angle with the non-chamfered portion of the top surface of the horizontal portion.

12. The system of claim 1 further comprising a plurality of fasteners; and
wherein the first rear bracket comprises a plurality of apertures extending through an entirety of a thickness of the first rear bracket; and
wherein each of the plurality of fasteners is carried by one of the plurality of apertures and secured to the first clamping bracket.

13. The system of claim 1 wherein the first rear bracket further comprises a second inner surface adapted to contact the shipboard electronic component.

14. The system of claim 1 wherein the first rear bracket further comprises:
a horizontal portion extending parallel to the second inner surface;
a vertical portion extending perpendicular to the horizontal portion; and
an angled surface extending an entirety of the distance from the horizontal portion to the vertical portion; and
wherein the angled surface forms a 135-degree angle with the horizontal portion; and
wherein the angled surface forms a 135-degree angle with the vertical portion.

15. The system of claim 1 wherein the first rear bracket further comprises:
a vertical portion extending perpendicular to the second inner surface and parallel to the inner surface;
a side surface opposing the inner surface of the first horizontal member;
a back surface perpendicular to the side surface and the first horizontal member; and
an angled surface extending directly between the side surface and the back surface; and
wherein the angled surface forms a 210-degree angle with the side surface; and
wherein the angled surface forms a 240-degree angle with the back surface.

16. The system of claim 1 wherein the first rear bracket further comprises:
a horizontal portion;
a vertical portion extending perpendicular to the horizontal portion;
a second inner surface forming a ninety-degree angle with the first inner surface and located along the horizontal portion;
a third inner surface located at a 270-degree angle to the second inner surface and parallel to the first inner surface;
an arcuate surface extending directly between the second inner surface and the third inner surface.

17. The system of claim 16 wherein the first rear bracket further comprises:
a vertical portion having a side surface opposing the first horizontal member; and
wherein the third inner surface opposes the side surface.

18. The system of claim 17 wherein the horizontal portion has a total thickness from a front surface to a chamfer end;
wherein a first thickness extends from the front surface to a chamfer start located on a top surface of the horizontal portion;
wherein a second thickness extends from the chamfer start to the chamfer end;
wherein the combination of the first thickness and second thickness equals the total thickness;
wherein a chamfer is located along a top surface of the horizontal portion beginning at the chamfer start and ending at the chamfer end;
wherein the chamfer forms a 114-degree angle with the non-chamfered portion of the top surface of the horizontal portion.

19. The system of claim 1 wherein the first clamping bracket comprises:
a vertical portion extending parallel to the inner surface; and
a horizontal portion secured to a first end of the vertical portion and forming a ninety-degree angle therewith.

20. The system of claim 19 further comprising a plurality of fasteners; and
wherein the vertical portion of the first clamping bracket comprises a plurality of apertures extending through an entirety of a thickness of the first clamping bracket; and
wherein each of the plurality of fasteners is carried by one of the plurality of apertures and secured to the first rear bracket.
